(19) United States
(12) Patent Application Publication
(10) Pub. No.: US 2025/0196585 A1
(43) Pub. Date: Jun. 19, 2025

(54) VEHICLE REAR STRUCTURE

(71) Applicant: TOYOTA JIDOSHA KABUSHIKI KAISHA, Toyota-shi (JP)

(72) Inventor: Masayuki OKANO, Toyota-shi (JP)

(73) Assignee: TOYOTA JIDOSHA KABUSHIKI KAISHA, Toyota-shi (JP)

(21) Appl. No.: 18/952,288

(22) Filed: Nov. 19, 2024

(30) Foreign Application Priority Data
Dec. 19, 2023 (JP) 2023-213948

(51) Int. Cl. B60H 1/24; B60H 1/26

(52) U.S. Cl. CPC B60H 1/244; B60H 1/26

(57) ABSTRACT

The vehicle rear structure includes a rear bumper of the vehicle, a fender panel disposed inside the rear bumper, and a partition wall provided in a space surrounded by the fender panel and partitioning the space into an upper portion and a lower portion, and the partition wall is provided with a communication hole for communicating the space partitioned between the upper portion and the lower portion.

### CROSS-REFERENCE TO RELATED APPLICATION

This application claims priority to Japanese Patent Application No. 2023-213948 filed on Dec. 19, 2023, incorporated herein by reference in its entirety.

### BACKGROUND

### 1. Technical Field

The present disclosure relates to a vehicle rear structure.

### 2. Description of Related Art

In a vehicle, noise easily enters a vehicle cabin from outside the vehicle cabin through a vent duct or a space along a wheel arch. In particular, in the case of a vehicle in which a vehicle cabin and a luggage compartment are adjacent to each other, noise more easily arrives at an occupant, which may lead to a deterioration in ride comfort. Therefore, in order to achieve comfortable in-vehicle environment, there has been conventionally proposed a vehicle rear structure that effectively suppresses entrance of noise.

Japanese Unexamined Patent Application Publication No. 2012-144155 (JP 2012-144155 A) discloses a rear structure of a vehicle having a configuration in which air ventilation is performed by vertically partitioning a space formed in a vehicle body side wall by a first partition and a second partition. In the rear structure of the vehicle, the first partition and the second partition can effectively suppress the noise outside the vehicle cabin that has entered the vehicle body side wall from an opening from being transmitted to the upper space. In addition, since the installation of sound absorbing materials is unnecessary, a simple configuration can be also achieved.

### SUMMARY

In order to suppress noise from entering the vehicle cabin from outside the vehicle cabin, for example, a member may be installed, such as a partition wall that partitions a space surrounded by a rear bumper and a fender panel disposed inside the rear bumper into upper and lower spaces. In such a configuration, it is necessary to suppress noise from being transmitted to both of the upper space and the lower space, and it is also necessary to consider the drainage performance in a case where water enters the upper space. On the other hand, due to countermeasures against noise and drainage, another problem may occur such as an increase in the number of components or a deterioration in the air permeability.

Therefore, the present specification provides a vehicle rear structure making it possible to reduce noise entering a vehicle cabin from outside the vehicle cabin without deteriorating air permeability and drainage performance.

A vehicle rear structure disclosed in the present specification comprises a partition wall that is provided in a space surrounded by a rear bumper of a vehicle and a fender panel disposed inside the rear bumper and partitions the space into an upper space and a lower space, in which

the partition wall is provided with a communication hole allowing communication between the upper space and the lower space into which the space is partitioned.

The above configuration makes it possible to achieve a resonator structure in which the upper space functions as an expansion chamber by the partition wall and the communication hole, enabling a reduction in noise entering both of the upper and lower spaces.

In addition, in the vehicle rear structure, a surface connecting from each end of the partition wall to a portion provided with the communication hole is formed in a shape protruding upward.

The above configuration makes it possible to suppress generation of air vortices below both ends of the partition wall, and to improve air resistance.

Furthermore, the vehicle rear structure further comprises a vent duct having a vent port communicating between inside and outside of a vehicle cabin, in which the partition wall is provided above the vent duct.

The above configuration makes it possible to suppress the noise from entering the vehicle cabin from outside of the vehicle cabin without deteriorating the air permeability through the vent duct.

A vehicle rear structure disclosed in the present specification comprises a partition wall that is provided in a space surrounded by a rear bumper of a vehicle and a fender panel disposed inside the rear bumper and partitions the space into an upper space and a lower space, in which

the partition wall includes a side branch pipe protruding upward from the partition wall.

The above configuration makes it possible to reduce the noise in the lower space by taking the noise in the lower space into the side branch pipe.

In addition, a plurality of side branch pipes is provided in the vehicle rear structure.

The above configuration makes it possible to further enhance the noise reduction effect by the plurality of side branch pipes.

According to the vehicle rear structure disclosed in the present specification, it is possible to suppress noise from entering the vehicle cabin from outside the vehicle cabin without deteriorating the air permeability or the drainage performance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating a vehicle to which a vehicle rear structure according to an embodiment is applied;

FIG. 2A is a IIA-IIA cross-sectional view of the vehicle rear structure of FIG. 1;

FIG. 2B is a IIB-IIB cross-sectional view of a partition wall in the vehicle rear structure of FIG. 2A;

FIG. 3A is a diagram for comparing an exemplary vehicle rear structure with a conventional structure;

FIG. 3B is a diagram for comparing an exemplary vehicle rear structure with a conventional structure;

FIG. 3C is a diagram for comparing an exemplary vehicle rear structure with a conventional structure;

FIG. 4A is a diagram for comparing an exemplary vehicle rear structure with a conventional structure;

FIG. 4B is a diagram for comparing an exemplary vehicle rear structure with a conventional structure;

FIG. 5A is a diagram for comparing an exemplary vehicle rear structure with a conventional structure;

FIG. 5B is a diagram for comparing an exemplary vehicle rear structure with a conventional structure; and

FIG. 6 is a diagram illustrating another example of a vehicle rear structure.

### DETAILED DESCRIPTION OF EMBODIMENTS

Hereinafter, a vehicle rear structure will be described with reference to the drawings. In the drawings, “Fr”, “Up”, and “Rh” indicate the front side, the upper side, and the right side, respectively.

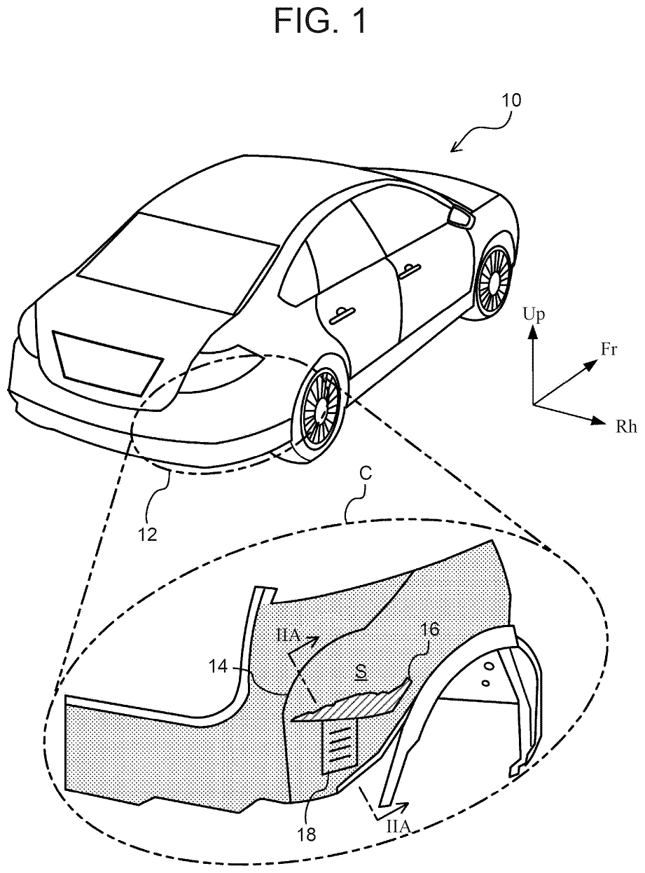

FIG. 1 is a perspective view schematically illustrating a vehicle to which a vehicle rear structure according to an embodiment is applied. More specifically, FIG. 1 is a rear perspective view of a vehicle to which the vehicle rear structure 10 is applied. In FIG. 1, the right side portion of the rear bumper 12 is surrounded by a two-dot chain line. In FIG. 1, the rear bumper 12 surrounded by the two-dot chain line is removed, that is, a view showing the inside of the rear bumper 12 is shown as an enlarged view C surrounded by the two-dot chain line.

As shown in the enlarged view C of FIG. 1, the vehicle rear structure 10 includes a fender panel 14 disposed inside the rear bumper 12. The fender panel 14 is a known fender panel which is one of the constituent panels of the vehicle body. As shown in the enlarged view C, the vehicle rear structure 10 has a space S surrounded by the rear bumper 12 and the fender panel 14. The space S is, for example, a space of about 3 cm to 5 cm in the vehicle-width direction. In the enlarged view C, the space S is shown as a thin ink portion.

As shown in the enlarged view C of FIG. 1, the vehicle rear structure 10 further includes a partition wall 16 that partitions the space S upward and downward, and a vent duct 18 that is assembled to the fender panel 14. Note that, in the enlarged view C, the partition wall 16 is indicated by a hatched portion in order to distinguish it from other members. The partition wall 16 is fixed to a part of the rear bumper 12 on the outer side in the vehicle width direction and to a part of the fender panel 14 on the inner side in the vehicle width direction by, for example, bonding using a double-sided tape (not shown in FIG. 1). The vent duct 18 is one of ventilation devices having a ventilation port for communicating the inside of the vehicle cabin with the outside of the vehicle cabin. As shown in the enlarged view C, the partition wall 16 is provided above the vent duct 18 in the vehicle vertical direction.

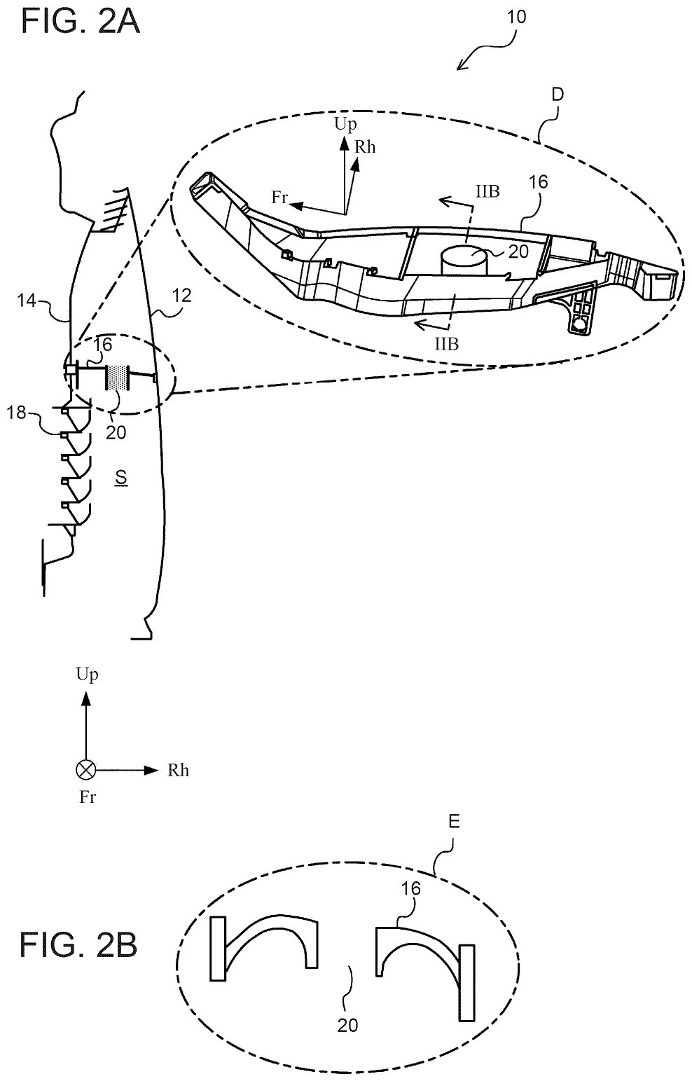

Next, referring to FIGS. 2A and 2B, the configuration of the vehicle rear structure 10 will be further described. FIG. 2A is a IIA-IIA cross-sectional view of the vehicle rear structure of FIG. 1. As shown in FIG. 2A, in the vehicle rear structure 10, a communication hole 20 that allows the space S to communicate with the partition wall 16 is provided. In FIG. 2A, the communication hole 20 is indicated by a thin ink portion. In addition, in FIG. 2A, the partition wall 16 is surrounded by a two-dot chain line and is shown as an enlarged view D. Further, in order to represent the shapes of the communication hole 20 and the periphery thereof, a cross section of the part is shown as a IIB-IIB cross-sectional view surrounded by a dashed-dotted line as FIG. 2B. As shown in IIB-IIB cross-sectional view of FIG. 2B, the respective surfaces connecting the both end portions of the partition wall 16 and the communication hole 20 are formed in a convex shape toward the upper side. Details of the partition wall 16 formed in the convex shape will be described later.

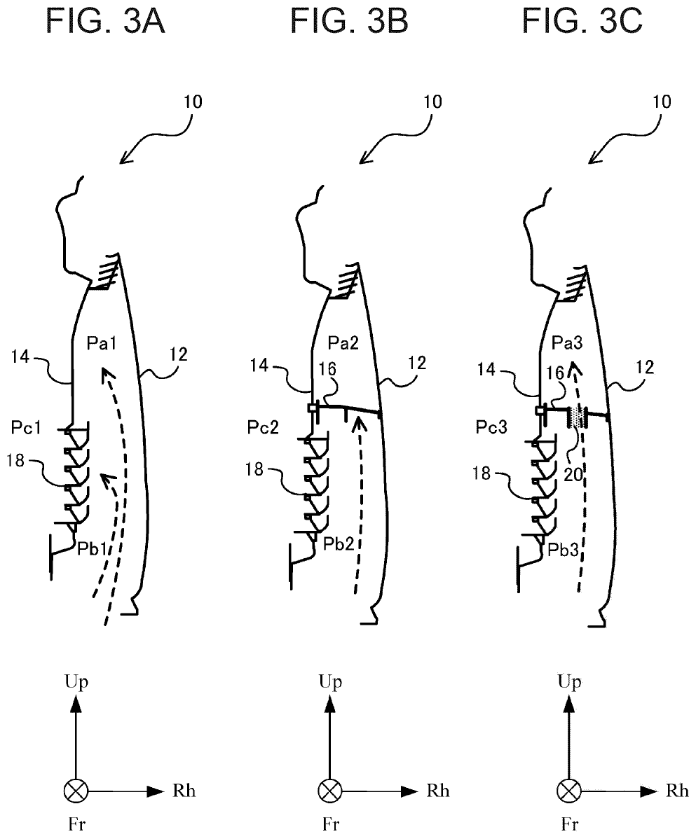

Next, the configuration of the vehicle rear structure 10 and the operation and effect thereof will be further described with reference to FIGS. 3A to 5B. FIGS. 3A to 5B are diagrams for comparing an exemplary vehicle rear structure with a conventional structure. Note that, in FIGS. 3A to 5B, the same parts as those of the vehicle rear structure 10 shown in FIG. 2A are respectively shown from the same directions. FIG. 3A is structured without a partition wall. FIG. 3B is structured with a partition wall. FIG. 3C is a structure in which a communication hole is further provided in a partition wall, which is a characteristic of a vehicle rear structure according to an embodiment. In the three configurations shown in FIGS. 3A to 3C, arrows indicated by broken lines represent images in which sounds from outside the vehicle cabin enter. In addition, Pa1, Pa2, Pa3 represent the loudness of the sound in the space above the space S surrounded by the rear bumper 12 and the fender panel 14 (reference numerals are abbreviated in FIGS. 3A to 6). Pb1, Pb2, Pb3 represent the loudness of the sound in the space below the space S. Pc1, Pc2, Pc3 represent the loudness of the sound in the vehicle cabin.

Here, when the loudness of the sound in the three structures is compared, it can be estimated that the sound Pa1 in the structure without the partition wall is largest above the space S. This is because the sound is more likely to penetrate upward than the other two structures in which there is no partition wall. Then, it can be estimated that the sound Pa3 in the configuration in which the communication hole 20 is provided in the partition wall 16 is the second largest. This is because a part of the sound from the lower side penetrates upward by the provision of the communication hole 20. That is, it can be estimated that the magnitude of the sound in the space above the space S is the magnitude relation of Pa1>Pa3>Pa2.

On the other hand, below the space S, it can be estimated that the sound Pb2 in the configuration in which the partition wall 16 without the communication hole is located is the largest. This is because the sound is not transmitted upward by the partition wall 16, and therefore it can be estimated that the sound pressure is increased due to reflection of the partition wall 16 or the like as compared with the other two structures. Next, when comparing the structure without the partition wall 16 and the structure with the communication hole 20 provided in the partition wall 16, it can be estimated that the sound in the space below the space S is larger in the structure without the partition wall 16. In the structure in which the communication hole 20 is provided in the partition wall 16, a resonator structure in which the space above the partition wall 16 and the communication hole 20 functions as an expansion chamber is realized. Therefore, the sound Pb3 can be estimated to be smaller than the sound Pb1 in the space where the sound damping structure is not provided. That is, it can be estimated that the magnitude of the sound in the space below the space S is the magnitude relation of Pb2>Pb1>Pb3.

When the loudness of the sound in the vehicle cabin is compared from the above-described Pa1>Pa3>Pa2 and Pb2>Pb1>Pb3, it can be estimated that the loudness is Pc1>Pc2>Pc3. That is, the structure disclosed in the present specification in which the communication hole 20 is provided in the partition wall 16 can reduce the noise in both the upper and lower spaces, and thus can further suppress the noise entering the vehicle cabin as compared with the other two structures. This is because, as described above, in the vehicle rear structure 10, the resonator structure is formed by the space S, the partition wall 16, and the communication hole 20, and the space above the space S serves as the expansion chamber, thereby realizing the sound-muffling structure. In this structure, for example, the muffling frequency can be adjusted by changing the length of the communication pipe portion in the vehicle vertical direction of the communication hole 20 or changing the area of the passage of the communication pipe. Therefore, for example, it is also possible to adopt a structure having a high sound-muffling effect depending on the vehicle type.

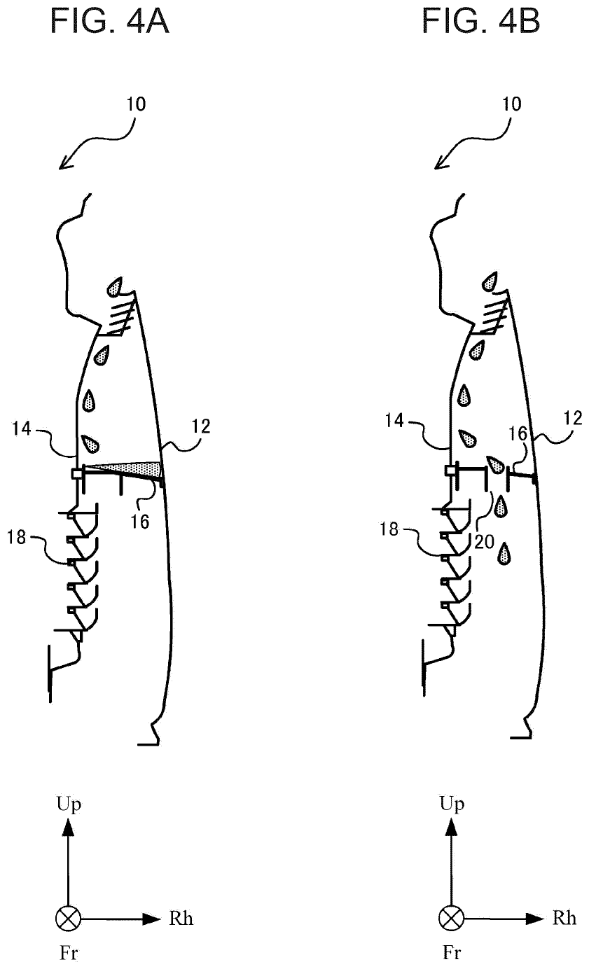

In FIG. 4A, a partition wall is provided. In FIG. 4B, a communication hole is further provided in the partition wall. The thin ink areas shown in FIGS. 4A and 4B represent water droplets. As shown in FIG. 4A, when the space is partitioned upward and downward by the partition wall 16, for example, water entering from an end portion of the bumper or the like may accumulate on the upper surface of the partition wall 16. On the other hand, as shown in FIG. 4B, in a configuration in which the communication hole 20 is provided in the partition wall 16, drainage is promoted from the communication hole 20. Therefore, in the structure in which the communication hole 20 is provided in the partition wall 16, there is a secondary effect that drainage is also improved.

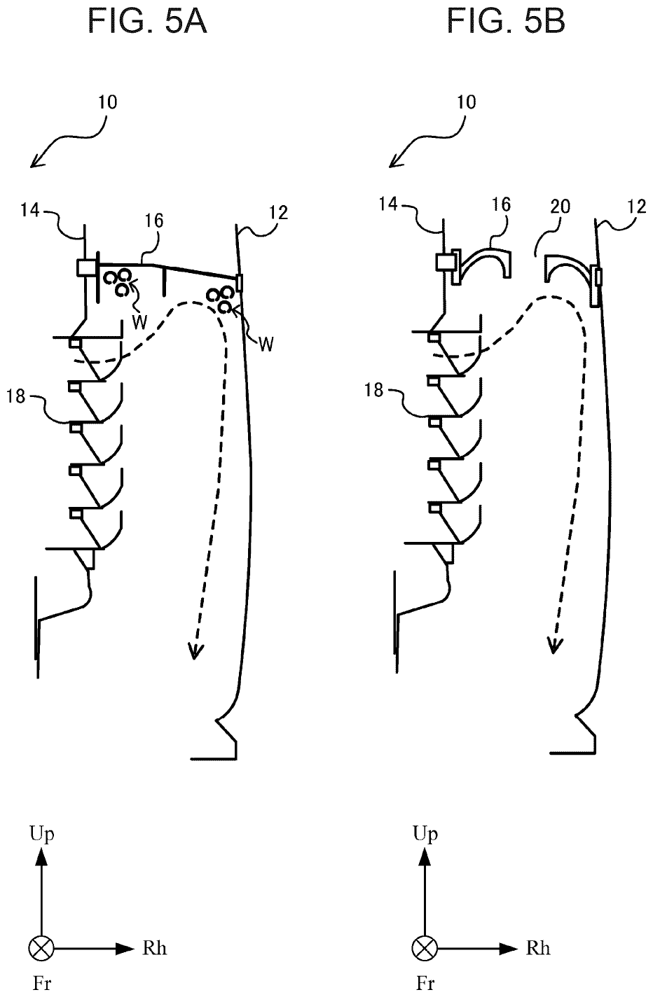

In FIG. 5A, a partition wall is provided. In FIG. 5B, a communication hole is further provided in the partition wall. In the two arrangements shown in FIGS. 5A and 5B, the arrows indicated by dashed lines represent an image of a portion of the airflow discharged from the inside of the vehicle cabin via the vent duct 18. As shown in FIG. 5A, in a configuration in which the partition wall 16 is provided, there is a possibility that a small vortex W is generated in the lower portion of the partition wall 16, particularly around the end portion. On the other hand, as shown in FIG. 5B, in the vehicle rear structure 10 in which the communication hole 20 is provided in the partition wall 16 and the respective surfaces connecting the both end portions of the partition wall 16 and the communication hole 20 are convex upward, it can be estimated that the peeling of the air around the end portion of the partition wall 16 is small. That is, in such a configuration, since the periphery of the end portion of the partition wall 16 is arcuate, since the air flows along the shape, the vortex is less likely to occur. Therefore, in the structure in which the communication hole 20 is provided in the partition wall 16, there is a secondary effect that the air resistance is also improved.

In the conventional configuration in which only the partition wall 16 is provided as shown in FIG. 5A, the end portion periphery of the partition wall 16 (that is, the portion where the vortex W is generated and the periphery thereof) is formed at an acute angle in its cross section. In the space portion, the sound tends to concentrate from the side having a large cross-sectional area toward the side having a small cross-sectional area, and in the conventional structure in which only the partition wall 16 is provided, the corner portion and the sound tend to concentrate. On the other hand, as shown in FIG. 5B, the partition wall 16 is provided with a communication hole 20, the respective surfaces connecting the both end portions of the partition wall 16 and the communication hole 20 is convex toward the upper, it is suppressed that the sound is concentrated in the corner portion. Therefore, in the structure in which the communication hole 20 is provided in the partition wall 16, there is also an effect that the concentration and amplification of the sound are suppressed.

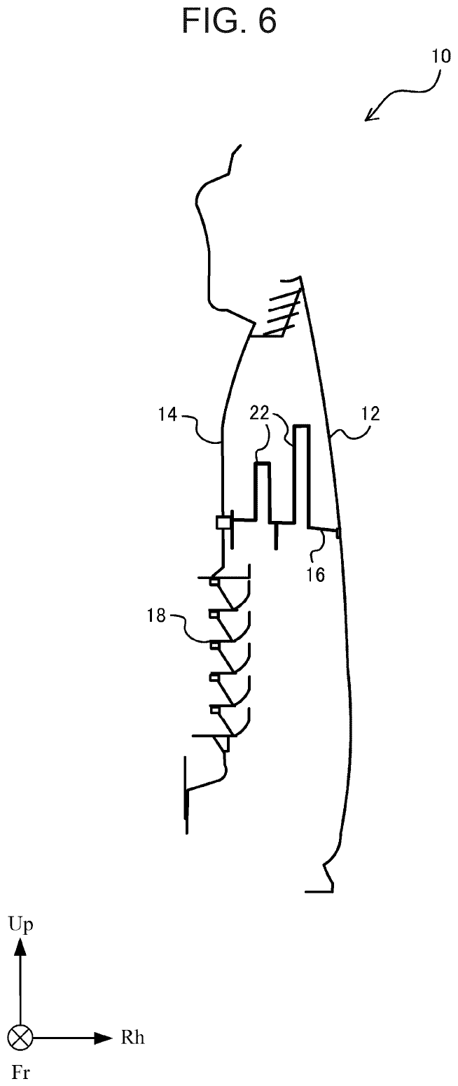

Next, a modification of the vehicle rear structure will be described with reference to FIG. 6. FIG. 6 is a diagram illustrating another example of a vehicle rear structure. Note that the same components as those in FIG. 2A are denoted by the same reference numerals, and explanations thereof will be omitted as appropriate. In the vehicle rear structure 10 shown in FIG. 6, the partition wall 16 has a side branch pipe 22 that protrudes upward from the partition wall 16. The side branch pipe 22 is formed integrally with the partition wall 16. By forming the side branch pipe 22, it is possible to take in the noise from the outside of the vehicle cabin that has entered the space below in the space S. As a result, noise entering the vehicle cabin can be suppressed. That is, noise is reduced by adding the internal space of the side branch pipe 22 to the space above the partition wall 16.

In addition, in FIG. 6, although two side branch pipes 22 having different lengths in the vehicle vertical direction are provided, a plurality of side branch pipes 22 having different shapes such as lengths and diameters are provided in this way, thereby enabling muffling of a plurality of frequencies. Further, by providing a plurality of side branch pipes 22 having the same length, it is also possible to more effectively muffle a specific frequency. Further, similarly to the vehicle rear structure 10 shown in FIG. 2A, in the vehicle rear structure 10 in the present modification, by providing the side branch pipe 22 above the vent duct 18, ventilation of the vent duct 18 in the space below in the space S is not hindered. Therefore, even in the vehicle rear structure according to the modified example, it is possible to achieve both the noise countermeasure and the air permeability.

Note that the description so far is an example. In the vehicle rear structure disclosed in the present specification, it is sufficient that a partition wall that partitions a space surrounded by the rear bumper and the fender panel into an upper portion and a lower portion is provided, and a communication hole that communicates the space partitioned into an upper portion and a lower portion is provided in the partition wall. Therefore, other configurations may be changed as appropriate. For example, in the present embodiment, the communication hole 20 is circular as shown in the enlarged view D of FIG. 2A, but not limited thereto, it may be formed from an elliptical or honeycomb-shaped.

What is claimed is:

1. A vehicle rear structure comprising a partition wall that is provided in a space surrounded by a rear bumper of a vehicle and a fender panel disposed inside the rear bumper and partitions the space into an upper space and a lower space, wherein the partition wall is provided with a communication hole allowing communication between the upper space and the lower space into which the space is partitioned.

2. The vehicle rear structure according to claim 1, wherein a surface connecting from each end of the partition wall to a portion provided with the communication hole is formed in a shape protruding upward.

3. The vehicle rear structure according to claim 1, further comprising a vent duct having a vent port communicating between inside and outside of a vehicle cabin, wherein the partition wall is provided above the vent duct.

4. A vehicle rear structure comprising a partition wall that is provided in a space surrounded by a rear bumper of a vehicle and a fender panel disposed inside the rear bumper and partitions the space into an upper space and a lower space, wherein the partition wall includes a side branch pipe protruding upward from the partition wall.

5. The vehicle rear structure according to claim 4, wherein a plurality of side branch pipes is provided.
